(19) United States
(12) Patent Application Publication
(10) Pub. No.: US 2013/0085627 A1
(43) Pub. Date: Apr. 4, 2013

(54) SYSTEM FOR REMOTE STARTING AND STOPPING OF ON-VEHICLE POWER TAKE-OFF SYSTEMS

(71) Applicant: Vanair Manufacturing Inc., Michigan City, IN (US)

(72) Inventors: David Lee Rausch, Laporte, IN (US); Ralph Kokot, JR., Schererville, IN (US)

(73) Assignee: VANAIR MANUFACTURING INC., Michigan City, IN (US)

(21) Appl. No.: 13/632,576

(22) Filed: Oct. 1, 2012

Related U.S. Application Data
(60) Provisional application No. 61/541,623, filed on Sep. 30, 2011.

(51) Int. Cl. G06F 17/00

(52) U.S. Cl. CPC G06F 17/00
USPC 701/2

(57) ABSTRACT

A system and method that enable remote wireless control of a PTO system on a vehicle. The system includes an input/output module, a display module electrically wired to the input/output module, and a key fob. The input/output module is configured to receive information relating to the operation of the power take-off unit and selectively deliver and interrupt electrical power to the power take-off unit. The display module is configured to communicate with the input/output module. The display module includes a control circuit and buttons operable to deliver to the input/output module control signals that command the input/output module. The key fob is adapted for wireless communication with the display module and includes buttons for wirelessly sending wireless signals to the display module by which the display module is caused to command the input/output module to selectively deliver and interrupt electrical power to the power take-off unit.

### CROSS REFERENCE TO RELATED APPLICATIONS

This application claims the benefit of U.S. Provisional Application No. 61/541,623, filed Sep. 30, 2011, the contents of which are incorporated herein by reference.

### BACKGROUND OF THE INVENTION

The present invention generally relates to systems adapted to control the operation of on-vehicle systems, and more particularly the control of power take-off (PTO) units used to power a compressor on a vehicle, for example, a utility, service, emergency or military vehicle.

Utility vehicles, service, emergency and military vehicles are often equipped with pneumatic systems, and therefore benefit from an on-board air compressor. Such air compressors may be powered by a PTO shaft driven by the engine of the vehicle. The resulting compressed air can be used directly or transmitted to any location around the vehicle and converted back into mechanical energy with a motor to provide a rotary or linear output. As with other fluid systems that deliver and contain a fluid at a high pressure or flow rate, the operation of a vehicle-mounted air compressor is preferably regulated so that its output is maintained at prescribed levels deemed safe and appropriate for the intended use of the compressed air. Commercially available systems for this purpose include the VANAIR® Total Electronic Control V-TEC™ Underdeck Speed Control and Diagnostic System.

Often, PTO units are engaged and disengaged with a hard wired switch, usually inside the vehicle. When arriving at a job site, the operator typically engages the PTO and, rather than periodically returning to the vehicle, leaves it engaged for the duration of the job so that equipment are continuously powered by the air compressor. This practice yields inefficient fuel and power usage since the PTO unit will be running even when the operation of equipment powered by the compressed air is not required.

In view of the above, there is a need for systems and methods that offer a more convenient method of engaging and disengaging a PTO unit used to power a compressor on a vehicle, for example, utility, service, emergency, and military vehicles.

### BRIEF DESCRIPTION OF THE INVENTION

The present invention provides a system and method therefor that enables remote wireless control of a PTO system on a vehicle, and particularly a PTO unit that powers a compressor of a vehicle.

According to a first aspect of the invention, a system is provided for controlling a power take-off unit installed on a vehicle. The system includes an input/output module, a display module electrically wired to the input/output module, and a key fob. The input/output module is configured to receive information relating to the operation of the power take-off unit and selectively deliver and interrupt electrical power to the power take-off unit. The display module is configured to receive the information from the input/output module and communicate commands to the input/output module. The display module includes a control circuit and buttons operable to deliver to the input/output module control signals that command the input/output module to selectively deliver and interrupt electrical power to the power take-off unit. The key fob is adapted for wireless communication with the display module and includes buttons for wirelessly sending wireless signals to the display module by which the display module is caused to command the input/output module to selectively deliver and interrupt electrical power to the power take-off unit.

According to a second aspect of the invention, a method is provided for operating a system to control a power take-off unit installed on a vehicle. The system includes an input/output module, a display module electrically wired to the input/output module, and a key fob. The input/output module is configured to receive information relating to the operation of the power take-off unit and selectively deliver and interrupt electrical power to the power take-off unit. The display module is configured to receive the information from the input/output module and communicate commands to the input/output module. The display module includes a control circuit and buttons operable to deliver to the input/output module control signals that command the input/output module to selectively deliver and interrupt electrical power to the power take-off unit. The key fob is adapted for wireless communication with the display module and includes buttons for wirelessly sending wireless signals to the display module by which the display module is caused to command the input/output module to selectively deliver and interrupt electrical power to the power take-off unit. The method includes operating the buttons on the key fob to wirelessly send the wireless signals to the display module to cause the display module to command the input/output module to deliver or interrupt electrical power to the power take-off unit.

A technical effect of the invention is the ability to engage and disengage a PTO system on a vehicle without requiring an operator to return to the vehicle. In particular, it is believed that, by configuring the PTO system to comprise a wireless remote, operators will be able to more easily engage and disengage the PTO system yielding more efficient use of the PTO system and, therefore, more efficient fuel use and power consumption.

Other aspects and advantages of this invention will be better appreciated from the following detailed description.

### BRIEF DESCRIPTION OF THE DRAWINGS

FIG. 1 is a perspective view representing a PTO system in accordance with an aspect of this invention.

### DETAILED DESCRIPTION OF THE INVENTION

The present invention is generally applicable to systems adapted to control the operation of on-vehicle systems, and more particularly the control of power take-off (PTO) units used to power attachments or other machines separate from the vehicle. Notable examples of such attachments include compressors, pumps, winches, hydraulic system, and mechanical systems of the vehicle. Vehicles that may benefit from the invention include, for example, utility, service, emergency, and military vehicles, though the invention has application to other vehicles and machinery as well.

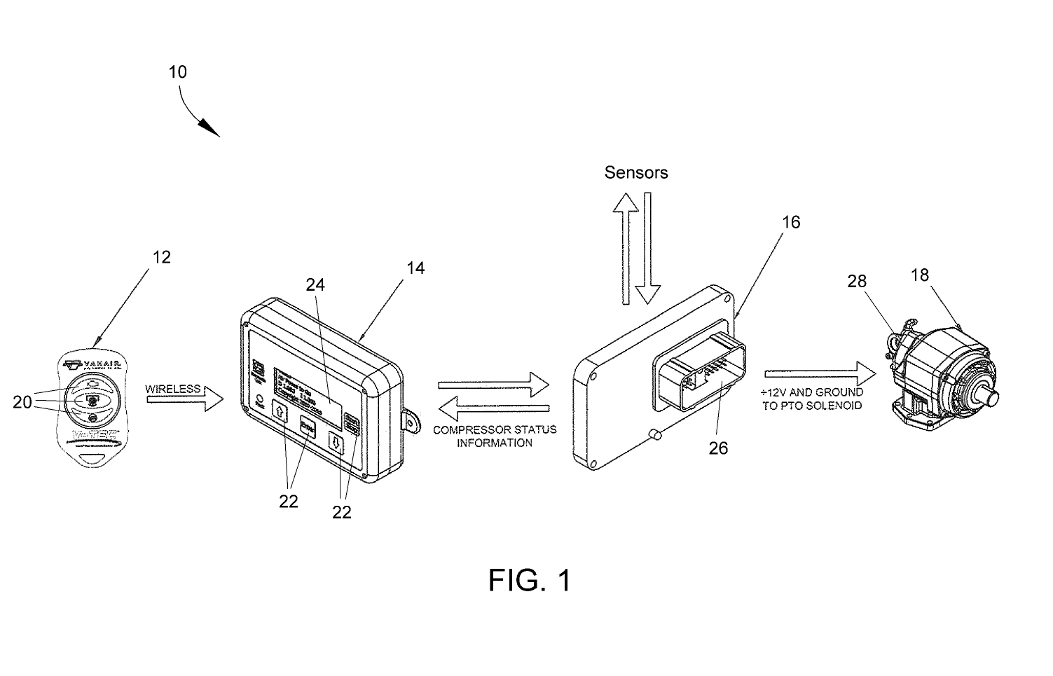

FIG. 1 represents a control system 10 that includes an input/output (I/O) module 16 adapted to selectively allow and interrupt the operation of a PTO gearbox 18. The control system 10 further includes a display module 14 electrically connected to the I/O module 16, and a key fob 12 that is configured for wireless communication with the display module 14.

The I/O module 16 preferably controls the PTO gearbox 18 by selectively providing electrical power to a PTO unit that includes the gearbox 18, for example, to energize and de-energize a solenoid 28 of a type conventionally provided with certain types of PTO gearboxes 18 to couple the gearbox 18 to an output shaft of an engine (not shown). As evident from FIG. 1, the I/O module 16 can also be configured to receive information from various sensors on a vehicle, including the operation of an attached unit, for example, a compressor (not shown), that is powered by the PTO unit through the PTO gearbox 18. The display module 14 preferably uses a J1939 protocol for communication with the I/O module 16, between which information regarding the status of the PTO unit and the compressor can be communicated to the display module 14 and control signals can be communicated from the display module 14 to the I/O module 16. The display module 14 may also receive and display vehicle information on a display screen 24, for example, system hours, service intervals, air pressure, fluid temperature and/or engine rpm through the J1939 channel of the vehicle.

The I/O module 16 contains control circuitry (not shown) that is preferably pre-programmed, for example, factory programmed settings, to be specifically configured for the vehicle and its particular engine, transmission, PTO unit (e.g., gear ratio), compressor, etc. In order to pre-program the I/O module 16, the display module 14 is preferably equipped with a USB port to allow communication with a computer (not shown), for example, a PC or a laptop, with which the I/O module 16 can be programmed with appropriate software or control settings. The control circuitry of the I/O module 16 can also be used to control the operation of the vehicle engine during PTO operation, including the control of engine speed in response to demands on units powered by the PTO unit, for example, an onboard compressor. The control circuitry of the I/O module 16 can further be used to control the operation of other components of the vehicle, for example, to lock-up a torque converter on the vehicle. The I/O module 16 and the display module 14 can both be located on the vehicle. For example, the I/O module 16 can be mounted in the engine compartment of the vehicle, whereas the display module 14 is more preferably installed in the passenger compartment of the vehicle.

The control circuitry of the display module 14 is preferably adapted to control vehicle engine speed and use engine speed as a control parameter for the operation of the PTO unit. In preferred embodiments of the invention, the display module 14 allows PTO engagement and operation of a compressor (or other unit powered by the PTO) at low engine speeds. If the unit powered by the PTO unit is a compressor, after engine start and PTO engagement, higher PTO speeds are preferably permitted once sufficient compressor sump pressure is attained. If there is no demand on the compressor and compressor output pressure rises above a predetermined set point, the display module 14 can issue a command to reduce engine speed. This feature can be overridden if the control software is aware of another unit powered by the PTO, for example, an on-vehicle generator, in which case the control software preferably maintains engine operation at speeds that are appropriate for the additional unit.

The key fob 12 is configured to wirelessly communicate with the display module 14 for the purpose of controlling the operation of the PTO unit, including starting and stopping the operation of the PTO gearbox 18, so as to also start and stop units powered by the PTO unit, for example, a compressor installed on the vehicle. Various wireless communication protocols are available and can be used for wireless communications between the key fob 12 and the display module 14. The key fob 12 can also be configured to start and stop the vehicle engine. The display module 14 can enable an operator to choose whether to control the PTO unit directly through input buttons 22 on the display module 14 (manual mode), or whether to enable remote control of the PTO unit with the key fob 12 (wireless mode). Preferably, the manual mode and the wireless mode can be enable simultaneously. The display module 14 also is preferably adapted to be capable of reassigning key fobs 12. For example, the display module 14 may comprise a pin hole (not shown) on the back side that allows access to an internal button which will reassign the key fob 12 to the display module 14. Other possible remote functions include, but are not limited to, remote loading and unloading of the compressor as well as remote activation and deactivation of a generator.

Preferred embodiments of the key fob 12 have three buttons 20, though fewer and more buttons are foreseeable. One button is preferably adapted to start and stop the PTO unit, for example, through energizing and de-energizing the solenoid 28 that controls the operation of the PTO gearbox 18. Two separate buttons are preferably provided to start and stop the vehicle engine. The key fob 12 and display module 14 are equipped with communications circuitry and antennas to enable wireless communication therebetween, preferably over a range of at least about 60 meters. To reduce the risk that the display module 14 will respond to unintended actuations of the buttons 20, the display module 14 preferably requires that inputs from the key fob 12 be received as double taps, in other words, two actuations of a button 20 within a prescribed time period, for example, within a time span of about one second.

Although the invention has been described above as comprising the display module 14, I/O module 16, and key fob 12 as separate components, it is foreseeable that all or some of these components can be combined into a single component.

In view of the above, it can be seen that a significant advantage of this invention is that the control system 10 enables wireless control of a PTO unit on a vehicle, which is achieved through a display module 14 and I/O module 16 that can be directly mounted on the vehicle. When wireless mode is enabled with the display module 14, the key fob 12 is enabled to start and stop the vehicle engine and engage and disengage the PTO unit, and therefore start and stop a compressor or other vehicle unit that receives power from the PTO unit. Accordingly, the wireless mode enables an operator to control the PTO unit and any unit powered by the PTO unit while the operator is located at a worksite at which the PTO-powered unit is being used, and therefore eliminates the need for the operator to return to the vehicle in order to start and stop the operation of the PTO-powered unit. In manual mode, the key fob 12 is disabled and control of the vehicle engine and PTO unit is only through the display module 14.

While the invention has been described in terms of a preferred embodiment, it is apparent that other forms could be adopted by one skilled in the art. For example, the physical configuration of the control system 10 could differ from that shown, and materials and processes other than those noted could be used. Therefore, the scope of the invention is to be limited only by the following claims.

1. A system for controlling a power take-off unit installed on a vehicle, the system comprising:
an input/output module configured to receive information relating to the operation of the power take-off unit and selectively deliver and interrupt electrical power to the power take-off unit;
a display module electrically wired to the input/output module to receive the information from the input/output module and communicate commands to the input/output module, the display module comprising a control circuit and buttons operable to deliver to the input/output module control signals that command the input/output module to selectively deliver and interrupt electrical power to the power take-off unit; and
a key fob adapted for wireless communication with the display module, the key fob comprising buttons for wirelessly sending wireless signals to the display module by which the display module is caused to command the input/output module to selectively deliver and interrupt electrical power to the power take-off unit.

2. The system of claim 1, wherein the key fob and display module are adapted to enable wireless communication therebetween over a range of at least 60 meters.

3. The system of claim 1, wherein the key fob is adapted to start and stop an engine of the vehicle.

4. The system of claim 1, wherein the key fob is adapted to start and stop a generator on the vehicle.

5. The system of claim 1, wherein the input/output module is adapted to control the operation of an engine of the vehicle during operation of the power take-off unit.

6. The system of claim 4, wherein the input/output module is adapted to control the speed of the engine in response to demands on units powered by the power take-off unit.

7. The system of claim 4, wherein the input/output module is adapted to lock-up a torque converter on the vehicle.

8. The system of claim 1, wherein the display module is adapted to use a J1939 protocol for communication with the I/O module.

9. The system of claim 1, wherein the display module is equipped with a universal serial bus port adapted for communication with a computer with which the display module can be programmed.

10. The system of claim 1, wherein the display module is adapted to be capable of reassigning key fobs.

11. The system of claim 1, wherein the input/output module is adapted to receive information from sensors on a compressor system.

12. The system of claim 1, wherein the display module comprises a manual mode wherein the key fob is disabled and a remote mode wherein the key fob is enabled.

13. The system of claim 1, wherein the power take-off unit is installed on a vehicle chosen from the group consisting of utility vehicles, service vehicles, emergency vehicles, and military vehicles.

14. A method of operating the system of claim 1 to control the power take-off unit installed on the vehicle, the method comprising operating the buttons on the key fob to wirelessly send the wireless signals to the display module to cause the display module to command the input/output module to deliver or interrupt electrical power to the power take-off unit.

15. A method of operating a system to control a power take-off unit installed on a vehicle, the system comprising an input/output module configured to receive information relating to the operation of the power take-off unit and selectively deliver and interrupt electrical power to the power take-off unit, a display module electrically wired to the input/output module to receive the information from the input/output module and communicate commands to the input/output module, the display module comprising a control circuit and buttons operable to deliver to the input/output module control signals that command the input/output module to selectively deliver and interrupt electrical power to the power take-off unit, and a key fob adapted for wireless communication with the display module, the key fob comprising buttons for wirelessly sending wireless signals to the display module by which the display module is caused to command the input/output module to selectively deliver and interrupt electrical power to the power take-off unit, the method comprising:
operating the buttons on the key fob to wirelessly send the wireless signals to the display module to cause the display module to command the input/output module to deliver or interrupt electrical power to the power take-off unit.

16. The method of claim 15, further comprising operating the buttons on the display module to enable a wireless mode setting prior to operating the buttons on the key fob.

17. The method of claim 15, wherein the buttons on the key fob may be operated over a range of at least 60 meters from the display module.

18. The method of claim 15, further comprising operating the buttons on the key fob to wirelessly send the wireless signals to the display module to cause the input/output module to command an engine of the vehicle to start and/or stop.

19. The method of claim 15, further comprising operating the buttons on the key fob to wirelessly send the wireless signals to the display module to cause the display module to command a generator on the vehicle to start and stop.

20. The method of claim 15, further comprising connecting a computer to the display module and programming the display module with the computer.

21. The method of claim 15, further comprising reassigning the key fob to the display module.

22. The method of claim 15, wherein the power take-off unit is installed on a vehicle chosen from the group consisting of utility vehicles, service vehicles, emergency vehicles, and military vehicles.
